(19) United States
(12) Patent Application Publication
(10) Pub. No.: US 2026/0253540 A1
(43) Pub. Date: Aug. 27, 2026

(54) DISPLAY PANEL AND DRIVING METHOD THEREFOR, AND DISPLAY APPARATUS

(71) Applicants: Chengdu BOE Optoelectronics Technology Co., Ltd., Chengdu, Sichuan (CN); BOE Technology Group Co., Ltd., Beijing (CN)

(72) Inventors: Yuanjie XU, Beijing (CN); Taofeng XIE, Beijing (CN)

(21) Appl. No.: 19/161,330

(22) PCT Filed: Jun. 17, 2024
(86) PCT No.: PCT/CN2024/099577

§ 371 Date: Sep. 2, 2025

(30) Foreign Application Priority Data
Jul. 26, 2023 (CN) 202310926864.5

(51) Int. Cl. G09G 3/3233; G09G 3/3266

(52) U.S. Cl. CPC G09G 3/3233; G09G 3/3266; G09G 2300/0408; G09G 2300/0819; G09G 2300/0842; G09G 2300/0861; G09G 2310/08; G09G 2330/021

(57) ABSTRACT

A display panel and driving method therefor, and a display apparatus. The display panel comprises: a plurality of gate drive circuits, and a plurality of sub-pixels in an array, each sub-pixel comprises a pixel drive circuit comprising a plurality of transistors, and a light-emitting element. The plurality of gate drive circuits are configured to output a plurality of gate drive signals to the transistors in the pixel drive circuit, each gate drive circuit outputs a gate drive signal, the plurality of gate drive signals are divided into at least two groups, gate drive signals in same group having same high-level voltage and same low-level voltage, the gate drive signals in different groups having different high-level voltages and/or different low-level voltages; the pixel drive circuit is configured to receive the plurality of gate drive signals, and drive, based on received plurality of gate drive signals, the light-emitting element to emit light.

### CROSS-REFERENCE TO RELATED APPLICATIONS

The present application is a U.S. National Phase Entry of International Application No. PCT/CN2024/099577 having an international filing date of Jun. 17, 2024, which claims the priority of Chinese patent application No. 202310926864.5, filed to the CNIPA on Jul. 26, 2023, the contents of which should be regarded as being incorporated into the present application herein by reference.

### TECHNICAL FIELD

Embodiments of the present disclosure relate to, but are not limited to, the field of display technologies, and particularly to a display panel and a driving method therefor, and a display apparatus.

### BACKGROUND

An organic light emitting diode (OLED) and a quantum-dot light emitting diode (QLED) are active light emitting display devices, and have advantages of self-illumination, a wide viewing angle, a high contrast ratio, low power consumption, an extremely high reaction speed, lightness and thinness, flexibility, and a low cost, etc. With constant development of display technologies, a flexible display apparatus (Flexible Display) in which the OLED or the QLED is used as a light emitting device and signal control is performed through a thin film transistor (TFT) has become a mainstream product in the field of display at present

### SUMMARY

The following is a summary of subject matters described herein in detail. This summary is not intended to limit the protection scope of claims.

A display panel is provided in an embodiment of the present disclosure, including a plurality of kinds of gate drive circuits, and further including a plurality of sub-pixels arranged in an array, a sub-pixel of the plurality of sub-pixels includes a pixel drive circuit and a light emitting element, the pixel drive circuit includes a plurality of transistors.

The plurality of kinds of gate drive circuits are configured to output a plurality of kinds of gate drive signals to the plurality of transistors in the pixel drive circuit, wherein each kind of gate drive circuits outputs one kind of gate drive signal, the plurality of kinds of gate drive signals are divided into at least two groups, high-level voltages of gate drive signals in a same group are the same, and low-level voltages of gate drive signals in a same group are the same; high-level voltages of gate drive signals in different groups are different, and/or low-level voltages of gate drive signals in different groups are different.

The pixel drive circuit is configured to receive the plurality of kinds of gate drive signals and drive the light emitting element to emit light according to the received plurality of kinds of gate drive signals.

A display apparatus is also provided according to an embodiment of the present disclosure, which includes the display panel in any one of the embodiments of the present disclosure.

A method for driving a display panel is also provided in an embodiment of the present disclosure. The method includes: controlling a plurality of kinds of gate drive circuits to output a plurality of kinds of gate drive signals to a plurality of transistors in a pixel drive circuit, wherein the plurality of kinds of gate drive signals are divided into at least two groups, high-level voltages of gate drive signals in a same group are the same, and low-level voltages of gate drive signals in a same group are the same; high-level voltages of gate drive signals in different groups are different, and/or low-level voltages of gate drive signals in different groups are different.

Other aspects of the present disclosure may be comprehended after the drawings and the detailed descriptions are read and understood.

### BRIEF DESCRIPTION OF DRAWINGS

Accompanying drawings are used for providing further understanding of technical solutions of the present disclosure, constitute a portion of the specification, and are used for explaining the technical solutions of the present disclosure together with embodiments of the present disclosure, but do not constitute limitations on the technical solutions of the present disclosure. Shapes and sizes of one or more components in the drawings do not reflect actual scales, but are only intended to schematically describe contents of the present disclosure.

FIG. 1 is a schematic diagram of a structure of a display apparatus.

FIG. 2 is a schematic plan view of a display panel.

FIG. 3A is a schematic diagram of a structure of a pixel drive circuit.

FIG. 3B is a diagram illustrating an operating process of the pixel drive circuit provided in FIG. 3A.

FIG. 4A is a schematic diagram of a structure of a display panel in an embodiment of the present disclosure.

FIG. 4B is a schematic diagram of a structure of a display panel in some technologies.

FIG. 5A is a schematic diagram of a structure of another pixel drive circuit.

FIG. 5B is a diagram illustrating an operating process of the pixel drive circuit provided in FIG. 5A.

### DETAILED DESCRIPTION

The embodiments of the present disclosure will be described below with reference to the drawings in detail. Implementations may be implemented in a plurality of different forms. Those of ordinary skills in the art may easily understand such a fact that modes and contents may be transformed into other forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the drawings, a size of one or more constituent elements, a thickness of a layer, or a region is sometimes exaggerated for clarity. Therefore, one implementation of the present disclosure is not necessarily limited to the size, and a shape and a size of one or more components in the drawings do not reflect an actual scale. In addition, the accompanying drawings schematically illustrate ideal examples, and an implementation of the present disclosure is not limited to shapes, numerical values, or the like shown in the drawings.

Ordinal numerals “first”, “second”, “third”, etc., in the specification are set not to form limits in numbers but only to avoid confusion between constituent elements. In the present disclosure, “plurality” represents two or more than two.

In the specification, for convenience, expressions “central”, “above”, “below”, “front”, “back”, “vertical”, “horizontal”, “top”, “bottom”, “inside”, “outside”, etc., for indicating directional or positional relationships are used to illustrate positional relationships between the constituent elements with reference to the accompanying drawings, not to indicate or imply that involved devices or elements are required to have specific orientations or are structured and operated in the specific orientations but only to easily describe the present specification and simplify the description, and thus should not be understood as limitations on the present disclosure. The positional relationships between the constituent elements are changed as appropriate according to directions of the constituent elements described. Therefore, appropriate replacements based on situations are allowed, which is not limited to the expressions in the specification.

In the specification, unless otherwise explicitly specified and defined, terms “mounting”, “coupling”, and “connection” should be understood in a broad sense. For example, it may be a fixed connection, a detachable connection, or an integral connection; it may be a mechanical connection or a connection; it may be a direct connection, an indirect connection through a middleware, or an internal communication between two elements. Those of ordinary skills in the art may understand meanings of the aforementioned terms in the present disclosure according to situations.

In the specification, an “electrical connection” includes a case that constituent elements are connected together through an element with a certain electrical effect. The “element with a certain electrical effect” is not particularly limited as long as electrical signals between the connected constituent elements can be transmitted. Examples of the “element with a certain electrical effect” not only include an electrode and a wiring, but also include a switching element (such as a transistor), a resistor, an inductor, a capacitor, and other elements with a plurality of functions, etc.

In the specification, a transistor refers to an element which at least includes three terminals, i.e., a gate, a drain, and a source. The transistor has a channel region between the drain (drain electrode terminal, drain region, or drain electrode) and the source (source electrode terminal, source region, or source electrode), and a current can flow through the drain, the channel region, and the source. In the specification, the channel region refers to a region through which a current mainly flows.

In the specification, a first electrode may be a drain and a second electrode may be a source, or, a first electrode may be a source and a second electrode may be a drain. In a case where transistors with opposite polarities are used, or in a case where a direction of a current is changed during operation of a circuit, or the like, functions of the “source” and the “drain” are sometimes interchangeable. Therefore, the “source” and the “drain” are interchangeable in the specification. In addition, the gate may also be referred to as a control electrode.

In the specification, “parallel” refers to a state in which an angle formed by two straight lines is −10° or above −10° and below 100 or 10°, and thus may include a state in which the angle is −5° or above −5° and below 5° or 5°. In addition, “perpendicular” refers to a state in which an angle formed by two straight lines is 800 or above 800 and below 1000 or 100°, and thus may include a state in which the angle is 85° or above 850 and below 950 or 95°.

In the specification, a circle, oval, triangle, rectangle, trapezoid, pentagon, or hexagon, etc. is not strictly speaking, but may be an approximate circle, oval, triangle, rectangle, trapezoid, pentagon, or hexagon, etc. Some small deformations due to tolerances may exist, for example, chamfers, arc edges, and deformations may exist.

In the present disclosure, “about” and “substantially” refer to that a boundary is not defined strictly and a case where process and measurement errors within their ranges exist is allowed. In the present disclosure, “substantially the same” refers to a case where numerical values differ by less than 10%.

In the present disclosure, “A extends along a B direction” means that A may include a main body portion and a secondary portion connected to the main body portion. The main body portion is a line, a line segment, or a strip-shaped body, the main body portion extends along the B direction, and a length of the main body portion extending along the B direction is greater than a length of the secondary portion extending along another direction. “A extends along the B direction” in the present disclosure always means “the main body portion of A extends along the B direction”.

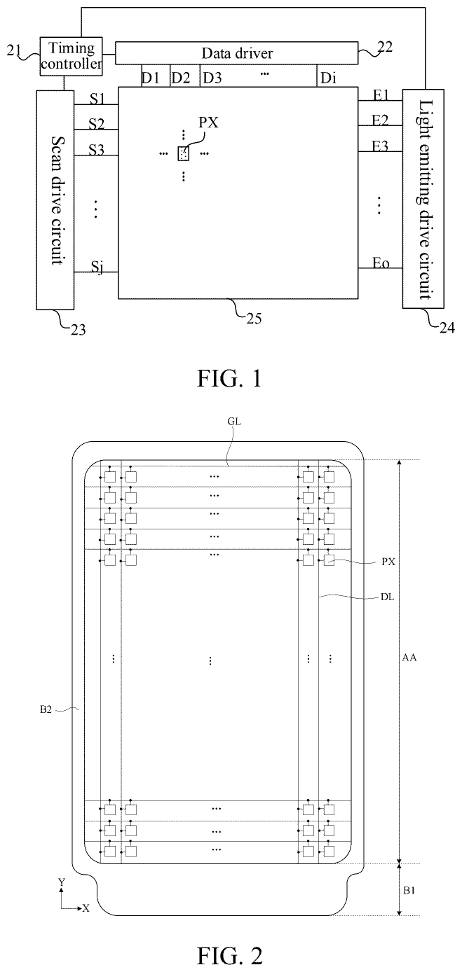

FIG. 1 is a schematic diagram of a structure of a display apparatus. In some examples, as shown in FIG. 1, the display apparatus may include a timing controller 21, a data driver 22, a scan drive circuit 23, a light emitting drive circuit 24 and a sub-pixel array 25. In some examples, the sub-pixel array 25 may include a plurality of sub-pixels PX arranged regularly. The scan drive circuit 23 may be configured to provide a scan signal to a sub-pixel PX through a scan signal line. The data driver 22 may be configured to provide a data voltage to the sub-pixel PX through a data line. The light emitting drive circuit 24 may be configured to provide a light emitting control signal to the sub-pixel PX through a light emitting control line. The timing controller 21 may be configured to control the scan drive circuit 23, the light emitting drive circuit 24 and the data driver 22.

In some examples, as shown in FIG. 1, the timing controller 21 may provide to the data driver 22 with a gray-scale value and a control signal suitable for a specification of the data driver 22; and the timing controller 21 may provide to the scan drive circuit 23 with a scan clock signal, a scan start signal, etc., suitable for a specification of the scan drive circuit 23; and the timing controller 21 may provide to the light emitting drive circuit 24 with a light emitting clock signal, a light emitting start signal, etc., suitable for a specification of the light emitting drive circuit 24. The data driver 22 may generate a data voltage to be provided to data lines D1 to Di, using the gray-scale value and the control signal received from the timing controller 21. For example, the data driver 22 may sample the gray-scale value using the clock signal and apply a data voltage corresponding to the gray-scale value to the data lines D1 to Di using a sub-pixel row as a unit. The scan drive circuit 23 may receive the scan clock signal, the scan start signal, etc., from the timing controller 21 to generate a scan signal to be provided to scan lines S1 to Sj. For example, the scan drive circuit 23 may provide sequentially a scan signal with an on-level pulse to the scan lines. In some examples, the scan drive circuit 23 may include a shift register and may generate a scan signal by means of sequentially transmitting a scan start signal provided in a form of an on-level pulse to a next-stage circuit under control of a scan clock signal. The light emitting drive circuit 24 may generate a light emitting control signal to be provided to light emitting control lines EM1 to Eo by the light emitting clock signal, the light emitting start signal, and the like received from the timing controller 21. For example, the light emitting drive circuit 24 may provide sequentially a light emitting control signal with an off-level pulse to the light emitting control lines. The light emitting drive circuit 24 may include a shift register, and generate a light emitting control signal by sequentially transmitting a light emitting start signal provided in a form of an off-level pulse to a next-stage circuit under control of the clock signal. Herein, i, j, and o are all natural numbers.

In some examples, the display apparatus may include a display panel. The sub-pixel array, the scan drive circuit and the light emitting drive circuit may be directly disposed on the display panel. For example, the scan drive circuit may be disposed on a left bezel of the display panel, and the light emitting drive circuit may be disposed on a right bezel of the display panel. Alternatively, each of the left bezel and the right bezel of the display panel may be provided with a scan drive circuit and a light emitting drive circuit. In some examples, the scan drive circuit and the light emitting drive circuit may be formed together with the sub-pixels in a process of forming the sub-pixels.

In some examples, the data driver may be disposed on a separate chip or a printed circuit board. For example, the data driver may be formed and disposed on a lower bezel of the display panel using a chip on glass, a chip on plastics, a chip on film, and the like, to be connected to a drive chip pin. The timing controller may be provided separately from or integrally with the data driver. However, the embodiment is not limited thereto.

FIG. 2 is a schematic plan view of a display panel. In some examples, as shown in FIG. 2, the display panel may include a display area AA, a bonding area B1 located on one side of the display area AA, and a bezel area B2 located on another side(s) of the display area AA. The bonding area B1 may be, for example, a lower bezel of the display panel, and the bezel area B2 may include an upper bezel, a left bezel and a right bezel of the display panel. In some examples, the display area AA may be a planarization area including a plurality of sub-pixels PX that form a sub-pixel array, and the plurality of sub-pixels PX are configured to display a dynamic picture or a still image. The display area may be referred to as an active area. In some examples, the display panel may be a flexible panel. Accordingly, the display panel may be deformable, for example, may be crimped, bent, folded, or curled.

In some examples, the bezel area B2 may include a circuit region, a power supply line region, a crack dam region and a cutting region which are sequentially disposed along a direction of the display area AA. The circuit region may be connected with the display area AA, and may at least include a plurality of cascaded gate drive circuits connected to a plurality of gate lines in the display area AA. The power supply line region is connected to the circuit region, and may at least include a low-level power supply line. The low-level power supply line may extend along a direction parallel to an edge of the display area, and may be connected to a cathode in the display area AA. The crack dam region may be connected to the power supply line region, and may at least include a plurality of cracks provided on a composite insulation layer. The cutting region may be connected to the crack dam region, and may at least include a cutting groove provided on the composite insulation layer, and the cutting grooves may be configured such that a cutting device can cut along the cutting grooves respectively after preparation of all films of the display panel is completed.

In some examples, the bonding area B1 and the bezel area B2 may be provided with a first isolation dam and a second isolation dam, which may extend in a direction parallel to an edge of the display area, to form a ring structure surrounding the display area AA, and the edge of the display area is an edge of a side of the display area close to the bonding area B1 or the bezel area B2.

In some examples, as shown in FIG. 2, the display area AA may at least include a plurality of sub-pixels PX, a plurality of gate lines Gate, and a plurality of data lines Data. The plurality of gate lines Gate may extend along a first direction X, and the plurality of data lines Data may extend along a second direction Y. Orthographic projections of the plurality of gate lines Gate on the base substrate intersect with orthographic projections of the plurality of data lines Data on the base substrate, to form a plurality of sub-pixel regions, and one sub-pixel PX is provided in each of the sub-pixel regions. The plurality of data lines Data are electrically connected with a plurality of sub-pixels PX, and the plurality of data lines Data may be configured to provide data signals to the plurality of sub-pixels PX. The plurality of Data lines Data may extend to the bonding area B1. The plurality of gate lines Gate are electrically connected with the plurality of sub-pixels PX, and the plurality of gate lines Gate may be configured to provide gate control signals to the plurality of sub-pixels PX. In some examples, the gate control signals may include a scan signal and a light emitting control signal.

In some examples, as shown in FIG. 2, the first direction X may be an extension direction (row direction) of the gate lines Gate in the display area AA, and the second direction Y may be an extension direction (column direction) of the data lines Data in the display area AA. The first direction X may intersect with the second direction Y. For example, the first direction X and the second direction Y may be perpendicular to each other.

In some examples, one pixel unit of the display area AA may include three sub-pixels, i.e. a red sub-pixel, a green sub-pixel and a blue sub-pixel. However, the embodiment is not limited thereto. In some examples, one pixel unit may include four sub-pixels, i.e. a red sub-pixel, a green sub-pixel, a blue sub-pixel and a white sub-pixel.

In some examples, a shape of a sub-pixel may be a rectangle, a rhombus, a pentagon, or a hexagon. When one pixel unit includes three sub-pixels, the three sub-pixels may be arranged side by side horizontally, side by side vertically, or in a shape of a Chinese character “ [symbol] ”. When one pixel unit includes four sub-pixels, the four sub-pixels may be arranged side by side horizontally, side by side vertically, or in a manner to form a square. However, the embodiment is not limited thereto.

In some examples, one sub-pixel may include a pixel drive circuit and a light emitting element electrically connected with the pixel drive circuit. The pixel drive circuit may include a plurality of transistors and at least one capacitor, for example, the pixel drive circuit may be of a 3T1C (i.e., three transistors and one capacitor) structure, a 7T1C (i.e., seven transistors and one capacitor) structure, a 5T1C (i.e., five transistors and one capacitor) structure, an 8T1C (eight transistors and one capacitor) structure, an 8T2C (eight transistors and two capacitors) structure, or the like.

In some examples, the light emitting element may be any one of a Light Emitting Diode (LED), an Organic Light Emitting Diode (OLED), a Quantum Dot Light Emitting Diode (QLED), a Micro LED (including a mini-LED or a micro-LED) and the like. For example, the light emitting element may be an OLED, and the light emitting element may emit red light, green light, blue light, or white light, etc. under drive of a pixel drive circuit corresponding to the light emitting element. A color of light emitted by the light emitting element may be determined as needed. In some examples, the light emitting element may include a first electrode, a second electrode, and an organic light emitting layer between the first electrode and the second electrode. A first electrode of the light emitting element may be electrically connected with a corresponding pixel drive circuit. However, the embodiment is not limited thereto.

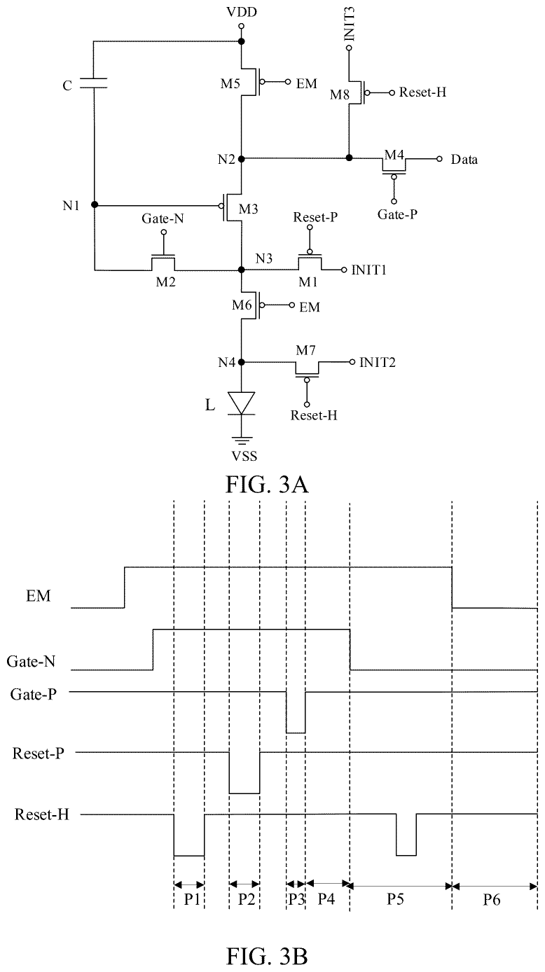

FIG. 3A is a schematic diagram of a structure of a pixel drive circuit. FIG. 3A is illustrated with an 8T1C structure as an example. As shown in FIG. 3A, the pixel drive circuit may be connected to eleven signal lines (a data line Data, a first scan line Gate-P, a second scan line Gate-N, a first reset line Reset-P, a second reset line Reset-H, a light emitting control line EM, a first initial signal line INIT1, a second initial signal line INIT2, a third initial signal line INIT3, a first power supply line VDD, and a second power supply line VSS). The gate lines include a first scan line Gate-P, a second scan line Gate-N, a first reset line Reset-P, a second reset line Reset-H and a light emitting control line EM.

In an exemplary implementation, as shown in FIG. 3A, a control electrode of a first transistor M1 is connected to the first reset line Reset-P, a first electrode of the first transistor M1 is connected to the first initial signal line INIT1, and a second electrode of the first transistor is connected to a third node N3. A control electrode of a second transistor M2 is connected with the scan signal line Gate-N, a first electrode of the second transistor M2 is connected with a first node N1, and a second electrode of the second transistor M2 is connected with a third node N3. A control electrode of a third transistor M3 is connected with the first node N1, a first electrode of the third transistor M3 is connected with a second node N2, and a second electrode of the third transistor M3 is connected with the third node N3. A control electrode of a fourth transistor M4 is connected with the first scan line Gate-P, a first electrode of the fourth transistor M4 is connected with the data line Data, and a second electrode of the fourth transistor M4 is connected with the second node N2. A control electrode of a fifth transistor M5 is connected with the light emitting signal line EM, a first electrode of the fifth transistor M5 is connected to the first power supply line VDD, and a second electrode of the fifth transistor M5 is connected with the second node N2. A control electrode of a sixth transistor M6 is connected with the light emitting control line EM, a first electrode of the sixth transistor M6 is connected with the third node N3, and a second electrode of the sixth transistor M6 is connected with a fourth node N4. A control electrode of a seventh transistor M7 is connected with the second reset line Reset-H, a first electrode of the seventh transistor M7 is connected with the second initial signal line INIT2, and a second electrode of the seventh transistor M7 is connected with the fourth node N4. A control electrode of an eighth transistor M8 is connected to the second reset line Reset-H, a first electrode of the eighth transistor M8 is connected to the third initial signal line INIT3, and a second electrode of the eighth transistor M8 is connected to the second node N2. A first terminal of a capacitor C is connected to the first power supply line VDD, and a second terminal of the capacitor C is connected with the first node N1.

In an exemplary implementation, a first electrode of a light emitting device is electrically connected to the fourth node N4, a second electrode of the light emitting device is connected to the second power supply line VSS.

In an exemplary implementation, a signal of the second power supply line VSS is a low-level signal, and a signal of the first power supply line VDD is a continuously provided high-level signal.

Transistors may be classified as N-type transistors and P-type transistors according to characteristics of the transistors. When a transistor is a P-type transistor, its turn-on voltage is a low-level voltage (e.g., 0V, −5V, −10V, or another suitable voltage), and its turn-off voltage is a high-level voltage (e.g., 5V, 10V, or another suitable voltage). When a transistor is an N-type transistor, its turn-on voltage is a high-level voltage (e.g., 5V, 10V, or another suitable voltage), and its turn-off voltage is a low-level voltage (e.g., 0V, −5V, −10V, or another suitable voltage).

In an exemplary implementation, the first transistor M1 to the eighth transistor M8 may be P-type transistors or N-type transistors. Use of a same type of transistors in a pixel drive circuit may simplify a process flow, reduce a process difficulty of a display panel, and improve a product yield. In some possible implementations, the first transistor M1 to the eighth transistor M8 may include P-type transistors and N-type transistors.

In an exemplary implementation, for the first transistor M1 to the eighth transistors M8, low temperature poly-silicon thin film transistors may be used, or oxide thin film transistors may be used, or both of low temperature poly-silicon thin film transistors and oxide thin film transistors may be used. An active layer of the low temperature poly silicon thin film transistor is made of Low Temperature Poly Silicon (LTPS for short), and an active layer of the oxide thin film transistor is made of an oxide semiconductor (Oxide). A Low temperature poly silicon thin film transistor has advantages such as a high migration rate and fast charging, and an oxide thin film transistor has advantages such as a low leakage current. The low temperature poly silicon thin film transistor and the oxide thin film transistor are integrated on one display panel to form a Low Temperature Polycrystalline Oxide (LTPO) display panel, so that advantages of both the low temperature poly silicon thin film transistor and the oxide thin film transistor may be utilized, low-frequency drive may be achieved, power consumption may be decreased, and display quality may be improved.

In an exemplary implementation, as shown in FIG. 3A, the second transistor M2 may be an N-type transistor, and the first transistor M1, the third transistor M3 to the eighth transistor M8 may be P-type transistors.

In this exemplary implementation, the first transistor M1, the seventh transistor M7 and the eighth transistor M8 may be referred to as reset transistors, the second transistor M2 may be referred to as a compensation transistor, the third transistor M3 may be referred to as a drive transistor, the fourth transistor M4 may be referred to as a data writing transistor, and the fifth transistor M5 and the sixth transistor M6 may be referred to as light emitting control transistors.

FIG. 3B is a diagram illustrating an operating process of the pixel drive circuit provided in FIG. 3A. In an exemplary implementation, the operating process of the pixel drive circuit may include following stages P1 to P6.

In the first stage P1, referred to as a first reset stage, a signal of the second reset line Reset-H is a low-level signal, and signals of the first reset line Reset-P, the first scan line Gate-P, the second scan line Gate-N and the light emitting control line EM are high-level signals. The signal of the second reset line Reset-H is a low-level signal, so that the seventh transistor M7 and the eighth transistor M8 are turned on, and the signal of the second initial signal line INIT2 is provided to the fourth node N4 to initialize (reset) the first electrode of the light emitting device L and clear original charges in the first electrode of the light emitting device L. A signal of the third initial signal line INIT3 is provided to the second node N2, to initialize (reset) the second node N2, and clear original charges in the second node N2. In this stage, the third transistor M3 is turned on. The signal of the second scan line Gate-N is a high-level signal, and the second transistor M2 is turned on. The signal of the second node N2 is provided to the first node N1 and the third node N3, and the first node N1 and the third node N3 are initialized. The signals of the first reset line Reset-P, the first scan line Gate-P and the light emitting control line EM are high-level signals, and the first transistor M1, the fourth transistor M4, the fifth transistor M5 and the sixth transistor M6 are turned off. The light emitting device L does not emit light in this stage.

In the second stage P2, referred to as a second reset stage, the signal of the first reset line Reset-H is a low-level signal, and signals of the second reset line Reset-H, the first scan line Gate-P, the second scan line Gate-N and the light emitting control line EM are high-level signals. The signal of the first reset line Reset-P is a low-level signal, so that signals of the first transistor M1 and the first initial signal line INIT1 are provided to the third node N3, to initialize (reset) the third node N3 again and clear original charges in the third node N3. In this stage, the third transistor M3 is continuously turned on. The signal of the second scan line Gate-N is a high-level signal, and the second transistor M2 is turned on. The third node N3 is provided to the first node N1 to continuously initialize the first node N1, signals of the second reset line Reset-H, the first scan line Gate-P, and the light emitting control line EM are high-level signals, and the fourth transistor M4, the fifth transistor M5, the sixth transistor M6, the seventh transistor M7, and the eighth transistor M8 are turned off. The light emitting device L does not emit light in this stage.

In the third stage P3, referred to as a data writing stage or a threshold compensation stage, the signal of the first scan line Gate-P is a low-level signal, and signals of the first reset line Reset-P, the second reset line Reset-H, the second scan line Gate-N and the light emitting control line EM are high-level signals. The data line Data outputs a data voltage. In this stage, the third transistor M3 is continuously turned on. The signal of the first scan line Gate-P is a low-level signal, so that the fourth transistor M4 is turned on. The signal of the second scan line Gate-N is a high-level signal, and the second transistor M2 is turned on. The data voltage outputted from the data line Data is provided to the first node N1 through the turned-on fourth transistor M4, the second node N2, the turned-on third transistor M3, the third node N3, and the turned-on second transistor M2, and a difference between the data voltage outputted from the data line Data and the threshold voltage of the third transistor M3 is charged into the capacitor C, a voltage at the second end of the capacitor C (the first node N1) is Vd−|Vth|, Vd is the data voltage outputted from the data line Data, and Vth is the threshold voltage of the third transistor M3. The signals of the first reset line Reset-P, the second reset line Reset-H, and the light emitting control line EM are high-level signals, and the first transistor M1, the fifth transistor M5, the sixth transistor M6, the seventh transistor M7, and the eighth transistor M8 are turned off. The light emitting device L does not emit light in this stage.

In the fourth stage P4, referred to as a continuous compensation stage, signals of the first reset line Reset-P, the second reset line Reset-H, the first scan line Gate-P, the second scan line Gate-N and the light emitting control line EM are high-level signals. The signal of the second scan line Gate-N is a high-level signal, the second transistor M2 is continuously turned on, the signals of the first scan line Gate-P, the first reset line Reset-P, the second reset line Reset-H and the light emitting control line EM are high-level signals, and the first transistor M1, the fourth transistor M4, the fifth transistor M5, the sixth transistor M6, the seventh transistor M7 and the eighth transistor M8 are turned off. Although the signal of the data line Data is stopped to write, the signal of the second node N2 is still provided to the first node N1 through the turned-on third transistor M3, the third node N3, and the turned-on second transistor M2, to continuously compensate the threshold voltage of the third transistor M3.

In the fifth stage P5, referred to as a bias stage, signals of the second scan line Gate-N and the second reset line Reset-H are low-level signals, and signals of the first reset line Reset-P, the first scan line Gate-P and the light emitting control line EM are high-level signals. The signal of the second scan line Gate-N is a low-level signal, the signals of the first scan line Gate-P, the first reset line Reset-P and the light emitting control line EM are high-level signals, and all of the first transistor M1, the second transistor M2, the fourth transistor M4, the fifth transistor M5 and the sixth transistor M6 are turned off. The signal of the second reset line Reset-H is a low-level signal, so that both the seventh transistor M7 and the eighth transistor M8 are turned on, the signal of the third initial signal line INIT3 is written to the second node N2 and the third node N3, and the signal of the second initial signal line INIT2 is written to the fourth node N4. In this stage, the third transistor M3 is in a biased state, and the light emitting device L does not emit light.

In the sixth stage P6, referred to as a light emitting stage, signals of the light emitting control line EM and the second scan line Gate-N are low-level signals, and signals of the first reset line Reset-P, the second reset line Reset-H and the first scan line Gate-P are high-level signals. The signal of the light emitting control line EM is a low-level signal, so that the fifth transistor M5 and the sixth transistor M6 are turned on, and a power supply voltage outputted from the first power supply line VDD provides a drive voltage to the first electrode of the light emitting device L through the turned-on fifth transistor M5, third transistor M3 and sixth transistor M6, so as to drive the light emitting device L to emit light.

In a drive process of the pixel drive circuit, a drive current flowing through the third transistor M3 (drive transistor) is determined by a voltage difference between the control electrode and the first electrode of the third transistor M3. Since a voltage of the first node N1 is Vdata−|Vth|, the drive current of the third transistor M3 is as follows.

$$I = K * {( Vgs - Vth )}^{2} = K * {[ ( Vdd - Vd + \vert Vth \vert ) - Vth ]}^{2} = K * {( Vdd - Vd )}^{2}$$

where I is the drive current flowing through the third transistor M3, i.e., a drive current for driving the light emitting device L, K is a constant, Vgs is a voltage difference between the control electrode and the first electrode of the third transistor M3, Vth is the threshold voltage of the third transistor M3, Vd is the data voltage output by the data line D, and Vdd is the power supply voltage output by the first power supply line VDD.

It may be seen from a derivation result of the above current formula that in the light emitting stage, the drive current of the third transistor M3 is not affected by the threshold voltage of the third transistor M3. Therefore, an influence of the threshold voltage of the third transistor M3 on the drive current is eliminated, which may ensure uniformity of display brightness of a display product, and improve an overall display effect of the display product.

At present, a mainstream image resolution (Pixels Per Inch, PPI) of the OLED display panel is between 400 and 450. However, with the maturity of display technology, the market demand for higher PPI products is becoming more and more urgent. Currently, the PPI of some display panels has increased to between 500 and 550. Higher PPI makes the charging time of each row of sub-pixels less (for example, the charging time of sub-pixels of some high-PPI products is about 1.6 us, and the charging time of sub-pixels of some mainstream PPI products is about 2.5 us), which causes relevant problems caused by insufficient charging, such as poor low-gray-scale image quality, poor image uniformity, color cast and other image quality problems.

How to improve the charging time and charging rate of high PPI products is an urgent problem to be solved at present. The charging rate of some high-PPI products is improved by reducing the resistance-capacitive loading (RC loading) of signal lines such as data lines and scan lines. However, an approach of reducing the RC loading of signal lines is mainly achieved by thickening thicknesses of an insulation layer and the planarization layer in the process, and trying to avoid an overlapping capacitance generated by signal lines between different layers. This approach increases a size of the display panel, which is not conducive to the thinness and lightness of the display panel.

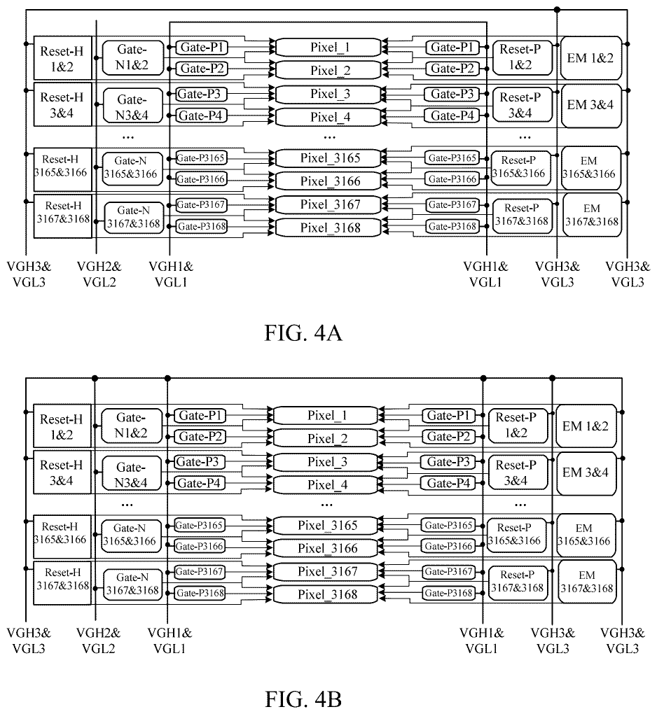

As shown in FIG. 4A, a display panel is provided in an embodiment of the present disclosure, including a plurality of kinds of gate drive circuits, and further including a plurality of sub-pixels arranged in an array, a sub-pixel includes a pixel drive circuit and a light emitting element, and the pixel drive circuit includes a plurality of transistors.

The plurality of kinds of gate drive circuits are configured to output a plurality of kinds of gate drive signals to the plurality of transistors in the pixel drive circuit, wherein each kind of gate drive circuit outputs one kind of gate drive signal, the plurality of kinds of gate drive signals are divided into at least two groups, high-level voltages of different groups of gate drive signals are different, and/or low-level voltages of different groups of gate drive signals are different.

The pixel drive circuit is configured to receive the plurality of kinds of gate drive signals and drive the light emitting element to emit light according to the received plurality of kinds of gate drive signals.

According to the display panel in the embodiment of the present disclosure, by dividing the plurality of kinds of gate drive signals into at least two groups, the high-level voltages of different groups of gate drive signals are different, and/or the low-level voltages of different groups of gate drive signals are different. The high and low-levels of the gate drive signals can be adjusted according to the influence of each group of gate drive signals on the charging rate, so that an optimal combination of the charging rate and power consumption can be achieved.

In some exemplary implementations, the gate drive circuit may be a Gate Driver On Array (GOA) circuit, and correspondingly, the gate drive signal may be a GOA drive signal.

For example, Table 1 is a table, for one type of display panel, of Data voltage Vdata, a voltage value VN1@RP of the first node N1 corresponding to a voltage jump point of the first reset line Reset-P, a voltage value VN1@EM of the first node N1 corresponding to the low-level stage of the light emitting control line EM, a ratio VN1@EM/Data of the voltage of first node N1 to a digital voltage corresponding to the low-level stage of the light emitting control line EM, and a current change rate I, when the high-level voltages of the first scan line Gate-P, the second scan line Gate-N, the first reset line Reset-P, and the light emitting control line EM range from 6.0V to 10.5V, respectively, and the gray-scale value is 10 and 128, respectively. Herein I=(max−min)/(max+min), where max represents a maximal current, and min represents a minimal current.

TABLE 1

| | | | | | | | | | | I (current | |
|---|---|---|---|---|---|---|---|---|---|---|---|
| | | | | | | | | | | change rate) | |
| | | V | | | | | | | | (max-min)/ | |
| | | Data | | N1@RP | | N1@EM | | N1@EM/Data | | (max + min) | |
| | | L10 | L128 | L10 | L128 | L10 | L128 | L10 | L128 | L10 | L128 |
| VGH_ | 6.0 | 6.45 | 4.75 | −2.8316 | −2.8317 | 2.1222 | 0.48395 | 32.90% | 10.19% | 50.66% | 23.18% |
| Gate-P | 6.5 | 6.45 | 4.75 | −2.8316 | −2.8317 | 2.1446 | 0.50528 | 33.25% | 10.64% | | |
| | 7.0 | 6.45 | 4.75 | −2.8316 | −2.8317 | 2.1675 | 0.52647 | 33.60% | 11.08% | | |
| | 7.5 | 6.45 | 4.75 | −2.8316 | −2.8317 | 2.1906 | 0.54761 | 33.96% | 11.53% | | |
| | 8.0 | 6.45 | 4.75 | −2.8316 | −2.8317 | 2.2128 | 0.56955 | 34.31% | 11.99% | | |
| | 8.5 | 6.45 | 4.75 | −2.8316 | −2.8317 | 2.2368 | 0.59177 | 34.68% | 12.46% | | |
| | 9.0 | 6.45 | 4.75 | −2.8316 | −2.8317 | 2.2609 | 0.6144 | 35.05% | 12.93% | | |
| | 9.5 | 6.45 | 4.75 | −2.8316 | −2.8317 | 2.2866 | 0.63871 | 35.45% | 13.45% | | |
| | 10.0 | 6.45 | 4.75 | −2.8316 | −2.8317 | 2.3111 | 0.66144 | 35.83% | 13.93% | | |
| | 10.5 | 6.45 | 4.75 | −2.8316 | −2.8317 | 2.3356 | 0.68454 | 36.21% | 14.41% | | |
| VGH_ | 6.0 | 6.45 | 4.75 | −2.8323 | −2.8322 | 2.332 | 0.67746 | 36.16% | 14.26% | 58.77% | 27.36% |
| Gate-N | 6.5 | 6.45 | 4.75 | −2.8322 | −2.832 | 2.3022 | 0.65044 | 35.69% | 13.69% | | |
| | 7.0 | 5.45 | 4.75 | −2.832 | −2.8319 | 2.2726 | 0.62357 | 35.23% | 13.13% | | |
| | 7.5 | 6.45 | 4.75 | −2.8319 | −2.8317 | 2.2432 | 0.59696 | 34.78% | 12.57% | | |
| | 8.0 | 6.45 | 4.75 | −2.8317 | −2.8316 | 2.2128 | 0.56957 | 34.31% | 11.99% | | |
| | 8.5 | 6.45 | 4.75 | −2.8316 | −2.8315 | 2.1855 | 0.54321 | 33.88% | 11.44% | | |
| | 9.0 | 6.45 | 4.75 | −2.8315 | −2.8314 | 2.1558 | 0.51669 | 33.42% | 10.88% | | |
| | 9.5 | 6.45 | 4.75 | −2.8314 | −2.8313 | 2.1265 | 0.49 | 32.97% | 10.32% | | |
| | 10.0 | 6.45 | 4.75 | −2.8313 | −2.8313 | 2.0984 | 0.46351 | 32.53% | 9.76% | | |
| | 10.5 | 6.45 | 4.75 | −2.8313 | −2.8312 | 2.0685 | 0.43699 | 32.07% | 9.20% | | |
| VGH_ | 6.0 | 6.45 | 4.75 | −2.8529 | −2.8531 | 2.2136 | 0.56964 | 34.32% | 11.99% | 0.39% | 0.14% |
| Reset- | 6.5 | 6.45 | 4.75 | −2.8476 | −2.8478 | 2.2135 | 0.56962 | 34.32% | 11.99% | | |
| P | 7.0 | 6.45 | 4.75 | −2.8423 | −2.8425 | 2.2133 | 0.5697 | 34.31% | 11.99% | | |
| | 7.5 | 6.45 | 4.75 | −2.8369 | −2.8372 | 2.2131 | 0.56969 | 34.31% | 11.99% | | |
| | 8.0 | 6.45 | 4.75 | −2.8316 | −2.8318 | 2.2129 | 0.56958 | 34.31% | 11.99% | | |
| | 8.5 | 6.45 | 4.75 | −2.8264 | −2.8267 | 2.2127 | 0.56951 | 34.31% | 11.99% | | |
| | 9.0 | 6.45 | 4.75 | −2.8213 | −2.8216 | 2.2123 | 0.56934 | 34.30% | 11.99% | | |
| | 9.5 | 6.45 | 4.75 | −2.8163 | −2.8166 | 2.213 | 0.56881 | 34.31% | 11.97% | | |
| | 10.0 | 6.45 | 4.75 | −2.8112 | −2.8115 | 2.2122 | 0.56852 | 34.30% | 11.97% | | |
| | 10.5 | 6.45 | 4.75 | −2.8061 | −2.8063 | 2.2109 | 0.56809 | 34.28% | 11.96% | | |
| VGH_ | 6.0 | 6.45 | 4.75 | −2.8316 | −2.8319 | 2.2123 | 0.56881 | 34.30% | 11.97% | 0.55% | 0.07% |
| Reset- | 6.5 | 6.45 | 4.75 | −2.8316 | −2.8319 | 2.2128 | 0.56897 | 34.31% | 11.98% | | |
| H | 7.0 | 6.45 | 4.75 | −2.8316 | −2.8319 | 2.213 | 0.56896 | 34.31% | 11.98% | | |
| | 7.5 | 6.45 | 4.75 | −2.8316 | −2.8319 | 2.2131 | 0.56892 | 34.31% | 11.98% | | |
| | 8.0 | 6.45 | 4.75 | −2.8316 | −2.8319 | 2.2128 | 0.56963 | 34.31% | 11.99% | | |
| | 8.5 | 6.45 | 4.75 | −2.8316 | −2.8319 | 2.2132 | 0.5694 | 34.31% | 11.99% | | |
| | 9.0 | 6.45 | 4.75 | −2.8316 | −2.8319 | 2.2129 | 0.56979 | 34.31% | 12.00% | | |
| | 9.5 | 6.45 | 4.75 | −2.8316 | −2.8319 | 2.2152 | 0.56958 | 34.34% | 11.99% | | |
| | 10.0 | 6.45 | 4.75 | −2.8316 | −2.8319 | 2.2152 | 0.56968 | 34.34% | 11.99% | | |
| | 10.5 | 6.45 | 4.75 | −2.8316 | −2.8319 | 2.2151 | 0.57026 | 34.34% | 12.01% | | |
| VGH_ | 6.0 | 6.45 | 4.75 | −2.8318 | −2.8315 | 2.2144 | 0.57217 | 34.33% | 12.05% | 0.84% | 0.12% |
| EM | 6.5 | 6.45 | 4.75 | −2.8318 | −2.8315 | 2.214 | 0.57145 | 34.33% | 12.03% | | |
| | 7.0 | 6.45 | 4.75 | −2.8318 | −2.8315 | 2.2136 | 0.57079 | 34.32% | 12.02% | | |
| | 7.5 | 6.45 | 4.75 | −2.8318 | −2.8315 | 2.2133 | 0.57016 | 34.31% | 12.00% | | |
| | 8.0 | 6.45 | 4.75 | −2.8318 | −2.8315 | 2.2129 | 0.56954 | 34.31% | 11.99% | | |
| | 8.5 | 6.45 | 4.75 | −2.8318 | −2.8315 | 2.2125 | 0.56892 | 34.30% | 11.98% | | |
| | 9.0 | 6.45 | 4.75 | −2.8318 | −2.8315 | 2.2121 | 0.56823 | 34.30% | 11.96% | | |
| | 9.5 | 6.45 | 4.75 | −2.8318 | −2.8315 | 2.2128 | 0.56723 | 34.31% | 11.94% | | |
| | 10.0 | 6.45 | 4.75 | −2.8318 | −2.8315 | 2.212 | 0.56648 | 34.29% | 11.93% | | |
| | 10.5 | 6.45 | 4.75 | −2.8318 | −2.8315 | 2.211 | 0.56566 | 34.28% | 11.91% | | |

Based on the data in Table 1, an influence of the VGH voltage of each GOA drive signal on a charging rate of the first node N1 is shown in Table 2.

TABLE 2

| | | | | | | Voltage | | | | |
|---|---|---|---|---|---|---|---|---|---|---|
| | | | | | | Change Rate | | | | |
| | Item | Voltage change | | | | of node Nl | | | | |
| | (VGH 6~ | rate of node N1 | | | | as Preset | | | | |
| | 10.5 V, in | as EM turning | | | | turning off | | Ioled change | | |
| | interval of | on (Max) | | VN1@EM/Data | | (Max) | | rate (Max) | | |
| No | 0.5 V) | L128 | L10 | L128 | L10 | L128 | L10 | L128 | L10 | Influence |
| 1 | Gate-P | −17.2% | −4.79% | 32.9% | 10.2% | −0.5% | −0.17% | 23.18% | 50.66% | Higher |
| | | | | ~36.1% | ~14.4% | | | | | |
| | | | | (6~ | (6~ | | | | | |
| | | | | 10.5V) | 10.5V) | | | | | |
| 2 | Gate-N | 21.5% | 5.99% | 36.2% | 14.3% | 0.2% | 0.2% | 27.36% | 58.77% | Higher |
| | | | | ~32.1% | ~9.2% | | | | | |
| | | | | (6~ | (6~ | | | | | |
| | | | | 10.5V) | 10.5V) | | | | | |
| 3 | EM | 0.25% | 0.09% | 34.3% | 12% | 1.04% | 0.13% | 0.12% | 0.84% | Lower |
| 4 | Reset-P | 0.91% | 0.43% | 34.3% | 12% | 0.54% | 0.21% | 0.14% | 0.39% | Lower |
| 5 | Reset-H | −1.07% | −0.3% | 34.3% | 12% | −1.85% | −0.8% | 0.07% | 0.55% | Lower |

Conclusion
An influence of VGH change on the voltage of the node N1 lies in mainly an influence of the Gate-P & Gate-N signal. It is guessed that it is caused by the parasitic capacitance affecting the voltage of the first node N1 at the moment of the Gate-P & Gate-N voltages jump.
Gate-P increases the voltage of the node N1. As the VGH voltage increases, the voltage of the first node N1 increases, and a writing rate of the first node N1 increases. VGH_Gate-P = 6V, Ioled is the maximum, and the voltage of the first node N1 is the minimum.
Gate-N decreases the voltage of the node N1. As the VGH voltage increases, the voltage of the first node N1 decreases, and the writing rate of the first node N1 decreases. VGH_Gate-N = 10.5 V, Ioled is the maximum, and the voltage of the first node N1 voltage is the minimum.
In order to increase the charging rate of the first node N1, it is recommended to increase VGH_Gate-P to 9V and decrease VGH_Gate-N to 7V for power consumption and optical testing.
VN1@EM/Data: 1) VGH_Gate-P = VGH_Gate-N = 8V: 34.31%; 2) VGH_Gate-P = 9V: 35.05%; 3) VGH_Gate-N = 7V: 35.23%; 4) VGH_Gate-P = 9V & VGH_Gate-N = 7V: 35.94%.

As can be seen from Table 2, the higher the signal voltage of the first scan line Gate-P is, the higher the charging rate of the first node N1 is, therefore, the high-level voltage VGH_Gate-P of the first scan line Gate-P should be set higher (e.g. 9V to 10V); and the lower the high-level voltage VGH_Gate-N of the second scan line Gate-N is, the higher the charging rate of the first node N1 is, therefore, the high-level voltage VGH_Gate-N of the second scan line Gate-N should be set lower (e.g. 6V to 7V), while the high-level voltages of the first reset line Reset-P, the second reset line Reset-H and the light emitting control line EM may be set as a conventional value, e.g., 7.5-8V, due to their lower influence on the charging rate of the first node N1.

As shown in FIG. 4B, in some techniques, the high-level and low-level signals of the plurality of kinds of GOA drive signals are set as a same signal respectively and can only be uniformly varied. For example, the high-level voltage VGH_Gate-P of the first scan line Gate-P, the high-level voltage VGH_Gate-N of the second scan line Gate-N and the high-level voltage VGH_EM of the light emitting control line EM are the same high-level signal. That is, the high-level voltages of the plurality of kinds of GOA drive signals can only be set as a same high-level voltage value, and the low-level voltages of the plurality of kinds of GOA drive signals can only be set as a same low-level voltage value. In the embodiments of the present disclosure, the plurality of kinds of GOA drive signals are divided into a plurality of groups to set according to different influences on the charging rate of the first node N1, and the plurality of groups of GOA drive signals can be set independently, and combined as needed to achieve an optimal configuration of high and low voltages. Compared with the unified high-level signal and the unified low-level signal, the high-level signals set separately can avoid a negative influence of a certain GOA drive signal. For example, increasing the high-level voltage increases the charging rate of the first node N1 in view of the first scan line Gate-P, but decreases the charging rate of the first node N1 in view of the second scan line Gate-N. By controlling the plurality of kinds of GOA drive signals separately, an optimal combination of charging rate and power consumption can be achieved.

In some exemplary implementations, the plurality of kinds of GOA drive signals may be divided into three groups, wherein the first group of GOA drive signals includes a first gate control signal provided by the first scan line Gate-P, the second group of GOA drive signals includes a second gate control signal provided by the second scan line Gate-N, and the third group of GOA drive signals includes a first reset control signal provided by the first reset line Reset-P, a second reset control signal provided by the second reset line Reset-N, and a light emitting control signal provided by the light emitting control line EM.

In some exemplary implementations, the high-level voltage of the first group of GOA drive signals is greater than the high-level voltage of the third group of GOA drive signals, and/or the low-level voltage of the first group of GOA drive signals is greater than the low-level voltage of the third group of GOA drive signals.

The high-level voltage of the second group of GOA drive signals is less than the high-level voltage of the third group of GOA drive signals, and/or the low-level voltage of the second group of GOA drive signals is less than the low-level voltage of the third group of GOA drive signals.

In some exemplary implementations, the high-level voltage of the first group of GOA drive signals ranges from 9V to 10V, the high-level voltage of the second group of GOA drive signals ranges from 6V to 7V, and the high-level voltage of the third group of GOA drive signals ranges from 7.5V to 8.5V.

For example, the high-level voltage of the first group of GOA drive signals may be 9.5V, the high-level voltage of the second group of GOA drive signals may be 6.5V, and the high-level voltage of the third group of GOA drive signals may be 8V.

In some exemplary implementations, the low-level voltage of the first group of GOA drive signals ranges from −6V to −7V, the low-level voltage of the second group of GOA drive signals ranges from −8V to −9V, and the low-level voltage of the third group of GOA drive signals ranges from −7V to −8V.

For example, the low-level voltage of the first group of GOA drive signals may be −6.5V, the low-level voltage of the second group of GOA drive signals may be −8.5V, and the low-level voltage of the third group of GOA drive signals may be −7.5V.

In some other exemplary implementations, the plurality of kinds of GOA drive signals may be divided into five groups, wherein the first group of GOA drive signals includes a first gate control signal provided by the first scan line Gate-P, the second group of GOA drive signals includes a second gate control signal provided by the second scan line Gate-N, the third group of GOA drive signals includes a first reset control signal provided by the first reset line Reset-P, the fourth group of GOA drive signals includes a second reset control signal provided by the second reset line Reset-N, and the fifth group of GOA drive signal includes a light emitting control signal provided by the light emitting control line EM.

In some other exemplary implementations, a high-level voltage of the first group of GOA drive signals is greater than a high-level voltage of the third group of GOA drive signals, and/or a low-level voltage of the first group of GOA drive signals is greater than a low-level voltage of the third group of GOA drive signals; and a high-level voltage of the second group of GOA drive signals is less than the high-level voltage of the third group of GOA drive signals, and/or a low-level voltage of the second group of GOA drive signals is less than the low-level voltage of the third group of GOA drive signals.

In some other exemplary implementations, a high-level voltage of the fourth group of GOA drive signals is equal to or approximately equal to the high-level voltage of the third group of GOA drive signals, and/or a low-level voltage of the fourth group of GOA drive signals is equal to or approximately equal to the low-level voltage of the third group of GOA drive signals.

In some other exemplary implementations, a high-level voltage of the fifth group of GOA drive signals is equal to or approximately equal to the high-level voltage of the third group of GOA drive signals, and/or a low-level voltage of the fifth group of GOA drive signals is equal to or approximately equal to a low-level voltage of the third group of GOA drive signals;

In the embodiments of the present disclosure, A is approximately equal to B means that a magnitude of a difference between A and B is within a range of a preset difference threshold. For example, the preset difference threshold may be 1.

In some other exemplary implementations, the high-level voltage of the first group of GOA drive signals ranges from 9V to 10V, the high-level voltage of the second group of GOA drive signals ranges from 6V to 7V, the high-level voltage of the third group of GOA drive signals ranges from 7.5V to 8.5V, the high-level voltage of the fourth group of GOA drive signals ranges from 7.5V to 8.5V, and the high-level voltage of the fifth group of GOA drive signals ranges from 7.5V to 8.5V.

For example, the high-level voltage of the first group of GOA drive signals may be 9.5V, the high-level voltage of the second group of GOA drive signals may be 6.5V, the high-level voltage of the third group of GOA drive signals may be 8V, the high-level voltage of the fourth group of GOA drive signals may be 8V, and the high-level voltage of the fifth group of GOA drive signals may be 8V.

In some other exemplary implementations, the low-level voltage of the first group of GOA drive signals ranges from −6V to −7V, the low-level voltage of the second group of GOA drive signals ranges from −8V to −9V, the low-level voltage of the third group of GOA drive signals ranges from −7V to −8V, the low-level voltage of the fourth group of GOA drive signals ranges from −7V to −8V, and the low-level voltage of the fifth group of GOA drive signals ranges from −7V to −8V.

For example, the low-level voltage of the first group of GOA drive signals may be −6.5V, the low-level voltage of the second group of GOA drive signals may be −8.5V, the low-level voltage of the third group of GOA drive signals may be −7.5V, the low-level voltage of the fourth group of GOA drive signals may be −7.5V, and the low-level voltage of the fifth group of GOA drive signals may be −7.5V.

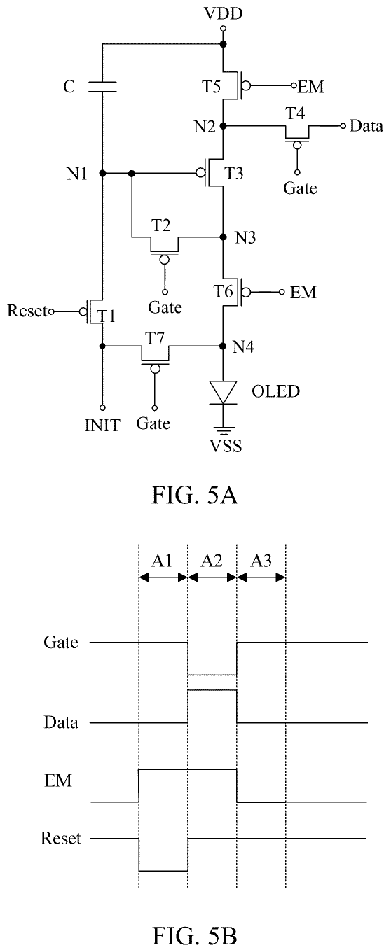

FIG. 5A is an equivalent circuit diagram of another pixel drive circuit according to an exemplary embodiment of the present disclosure. In some other exemplary implementations, as shown in FIG. 5A, the pixel drive circuit may include seven transistors (first transistor T1 to seventh transistor T7), one storage capacitor C, and a plurality of signal lines (data line Data, scan line Gate, Reset line Reset, initial signal line INIT, first power supply line VDD, second power supply line VSS and light emitting control line EM).

In some exemplary implementations, a control electrode of the first transistor T1 is connected to the reset line Reset, a first electrode of the first transistor T1 is connected to the initial signal line INIT, and a second electrode of the first transistor T1 is connected to a first node N1. A control electrode of the second transistor T2 is connected with the scan line Gate, a first electrode of the second transistor T2 is connected with the third node N3, and a second electrode of the second transistor T2 is connected with the first node N1. A control electrode of the third transistor T3 is connected with the first node N1, a first electrode of the third transistor T3 is connected with a second node N2, and a second electrode of the third transistor T3 is connected with the third node N3. A control electrode of the fourth transistor T4 is connected with the scan line Gate, a first electrode of the fourth transistor T4 is connected with the data line Data, and a second electrode of the fourth transistor T4 is connected with the second node N2. A control electrode of the fifth transistor T5 is connected with the light emitting signal line EM, a first electrode of the fifth transistor T5 is connected to the first power supply line VDD, and a second electrode of the fifth transistor T5 is connected with the second node N2. A control electrode of the sixth transistor T6 is connected with the light emitting control line EM, a first electrode of the sixth transistor T6 is connected with the third node N3, and a second electrode of the sixth transistor T6 is connected with the fourth node N4 (i.e., a first electrode of the light emitting element). A control electrode of the seventh transistor T7 is connected with the scan line Gate or the reset line Reset, a first electrode of the seventh transistor T7 is connected to the initial signal line INIT, and a second electrode of the seventh transistor T7 is connected to the fourth node N4. A first terminal of the storage capacitor C is connected to the first power supply line VDD, and a second terminal of the storage capacitor C is connected to the first node N1.

In some exemplary implementations, the first transistor T1 to the seventh transistor T7 may be P-type transistors or may be N-type transistors. Use of a same type of transistors in a pixel drive circuit may simplify a process flow, reduce a process difficulty of a display panel, and improve a product yield. In some possible implementations, the first transistor T1 to the seventh transistor T7 may include P-type transistor(s) and N-type transistor(s).

In some exemplary implementations, a second electrode of the light emitting element is connected to the second power supply line VSS, a signal of the second power supply line VSS is a low-level signal continuously provided, and a signal of the first power supply line VDD is a high-level signal continuously provided. The scan line Gate is the scan signal line in the pixel drive circuits of the present display row, and the reset line Reset is the scan signal line in the pixel drive circuits of a previous display row. That is, for an n-th display row, the scan line Gate is Gate (n) and the reset line Reset is Gate (n−1). The reset line Reset in the present display row and the scan line Gate in the pixel drive circuits of the previous display row may be the same signal line, to reduce the signal lines of the display panel and achieve a narrow bezel of the display panel.

In some exemplary implementations, all of the scan line Gate, the reset line Reset, the light emitting control line EM and the initial signal line INIT extend along a horizontal direction, and all of the second power supply line VSS, the first power supply line VDD and the data line Data extend along a vertical direction.

In some exemplary implementations, the light emitting element may be an Organic Light Emitting Diode (OLED), including a first electrode (anode), an organic light emitting layer, and a second electrode (cathode) that are stacked.

In this exemplary implementation, the first transistor T1 and the seventh transistor T7 may be referred to as reset transistors, the second transistor T2 may be referred to as a compensation transistor, the third transistor T3 may be referred to as a drive transistor, the fourth transistor T4 may be referred to as a data writing transistor, and the fifth transistor T5 and the sixth transistor T6 may be referred to as light emitting control transistors.

FIG. 5B is an operation timing diagram of the pixel drive circuit as shown in FIG. 5A. In the following, an exemplary embodiment of the present disclosure will be explained through an operating process of the pixel drive circuit, in which all the seven transistors in FIG. 5A are P-type transistors, shown in FIG. 5B. For example, an operating process of the pixel drive circuit may include the following first to third stages A1 to A3.

In the first stage A1, referred to as a reset stage, a signal of the reset line Reset is a low-level signal, and signals of the scan line Gate and the light emitting control line EM are high-level signals. The signal of the reset line Reset is a low-level signal, so that the first transistor T1 is turned on, and a signal of the initial signal line INIT is provided to a first node N1 to initialize the storage capacitor C, to clear an original data voltage in the storage capacitor. The signals of the scan line Gate and the light emitting control line EM are the high-level signals, so that the second transistor T2, the fourth transistor T4, the fifth transistor T5, the sixth transistor T6 and the seventh transistor T7 are turned off. In this stage, the OLED does not emit light.

In the second stage A2, referred to as a data writing stage or a threshold compensation stage, a signal of the scan line Gate is a low-level signal, signals of the reset line Reset and the light emitting control line EM are high-level signals, and the data line Data outputs a data voltage. In this stage, the second terminal of the storage capacitor C is at a low-level, so the third transistor T3 is turned on. The signal of the scan line Gate is the low-level signal, so that the second transistor T2, the fourth transistor T4 and the seventh transistor T7 are turned on. The second transistor T2 and the fourth transistor T4 are turned on, so that the data voltage output by the data line Data is provided to the first node N1 through the second node N2, the turned-on third transistor T3, the third node N3, and the turned-on second transistor T2, and a sum of the data voltage output by the data line Data and a threshold voltage of the third transistor T3 is charged into the storage capacitor C, wherein a voltage at the second terminal (the second node N2) of the storage capacitor C is Vdata+Vth, Vdata is the data voltage output by the data line Data, and Vth is the threshold voltage of the third transistor T3. The seventh transistor T7 is turned on, so that an initialization voltage of the initial signal line INIT is provided to a first electrode of the OLED to initialize (reset) the first electrode of the OLED and clear a pre-stored voltage therein, thereby completing initialization and ensuring that the OLED does not emit light. The signal of the reset line Reset is a high-level signal, so that the first transistor T1 is turned off. The signal of the light emitting control line EM is the high-level signal, so that the fifth transistor T5 and the sixth transistor T6 are turned off.

In the third stage A3, referred to as a light emitting stage, the signal of the light emitting control line EM is a low-level signal, and both the signals of the scan line Gate and the reset line Reset are high-level signals. The signal of the light emitting control line EM is a low-level signal, so that the fifth transistor T5 and the sixth transistor T6 are turned on. A power supply voltage output by the first power supply line VDD provides a drive voltage to the first electrode of the OLED through the turned-on fifth transistor T5, third transistor T3 and sixth transistor T6, to drive the OLED to emit light.

In a drive process of the pixel drive circuit, a drive current flowing through the third transistor T3 (drive transistor) is determined by a voltage difference between the control electrode and the first electrode of the third transistor T3. Since the voltage of the second node N2 is Vdata+Vth, the drive current of the third transistor T3 is:

$$I = K * {( Vgs - Vth )}^{2} = K * {[ ( Vdata + Vth - Vdd ) - Vth ]}^{2} = K * {[ ( Vdata - Vdd ) ]}^{2}$$

where I is the drive current flowing through the third transistor T3, that is, the drive current for driving an OLED, K is a constant, Vgs is a voltage difference between the control electrode and the first electrode of the third transistor T3, Vth is the threshold voltage of the third transistor T3, Vdata is the data voltage output by the data line Data, and Vdd is the power supply voltage output by the first power supply line VDD.

It may be seen from the above formula that a current I flowing through the light emitting element is uncorrelated to the threshold voltage Vth of the third transistor T3, so that an influence of the threshold voltage Vth of the third transistor T3 on the current I is eliminated, and uniformity of brightness is ensured.

Based on the abovementioned operation timing, in this pixel drive circuit, residual positive charges of the light emitting element, after the light emitting element emitted light last time, are eliminated, compensation for a gate voltage of the third transistor is achieved, an influence of drift of the threshold voltage of the third transistor on a drive current of the light emitting element is avoided, and uniformity of a displayed image and display quality of the display panel are improved.

In some exemplary implementations, the plurality of kinds of GOA drive signals include a gate control signal for controlling the data writing transistor to turn on and off, a reset control signal for controlling the reset transistor to turn on and off, and a light emitting control signal for controlling the light emitting control transistor to turn on and off, and the plurality of kinds of GOA drive signals are divided into two groups, wherein the first group includes the gate control signal, and the second group includes the light emitting control signal.

In some exemplary implementations, the first group of GOA drive signals includes the reset control signal when the reset control signal and the gate control signal are correlated signals; and the second group of gate drive signals includes the reset control signal when the reset control signal and the gate control signal are uncorrelated signals.

In some exemplary implementations, a high-level voltage of the first group of GOA drive signals is greater than a high-level voltage of the second group of GOA drive signals, and/or a low-level voltage of the first group of GOA drive signals is greater than a low-level voltage of the second group of GOA drive signals.

In some other exemplary implementations, the pixel drive circuit includes a drive transistor, a data writing transistor, a reset transistor, a light emitting control transistor and a compensation transistor.

The plurality of kinds of GOA drive signals include a first gate control signal for controlling the data writing transistor to turn on and off, a second gate control signal for controlling the compensation transistor to turn on and off, a reset control signal for controlling the reset transistor to turn on and off, and a light emitting control signal for controlling the light emitting control transistor to turn on and off.

The plurality of kinds of GOA drive signals are divided into three groups, wherein the first group includes a first gate control signal, the second group includes a second gate control signal, and the third group includes a reset control signal and a light emitting control signal.

In some exemplary implementations, the high-level voltage of the first group of GOA drive signals is greater than the high-level voltage of the third group of GOA drive signals, and/or the low-level voltage of the first group of GOA drive signals is greater than the low-level voltage of the third group of GOA drive signals.

The high-level voltage of the second group of GOA drive signals is less than the high-level voltage of the third group of GOA drive signals, and/or the low-level voltage of the second group of GOA drive signals is less than the low-level voltage of the third group of GOA drive signals.

In some exemplary implementations, the high-level voltage of the first group of GOA drive signals ranges from 9V to 10V, the high-level voltage of the second group of GOA drive signals ranges from 6V to 7V, and the high-level voltage of the third group of GOA drive signals ranges from 7.5V to 8.5V.

For example, the high-level voltage of the first group of GOA drive signals may be 9.5V, the high-level voltage of the second group of GOA drive signals may be 6.5V, and the high-level voltage of the third group of GOA drive signals may be 8V.

In some exemplary implementations, the low-level voltage of the first group of GOA drive signals ranges from −6V to −7V, the low-level voltage of the second group of GOA drive signals ranges from −8V to −9V, and the low-level voltage of the third group of GOA drive signals ranges from −7V to −8V.

For example, the low-level voltage of the first group of GOA drive signals may be −6.5V, the low-level voltage of the second group of GOA drive signals may be −8.5V, and the low-level voltage of the third group of GOA drive signals may be −7.5V.

A display apparatus is also provided in an embodiment of the present disclosure, which includes a display panel.

The display panel is the display panel in any one of the foregoing embodiments, implementation principle and implementation effects of which are similar to those of the display panel in any one of the foregoing embodiments, and will not be repeated here.

In an exemplary implementation, the display apparatus may be any product or component with a display function, such as a mobile phone, a tablet computer, a television, a display, a notebook computer, a digital photo frame, and a navigator. Other essential components of the display apparatus, which should be contained in the display apparatus based on the understanding of those of ordinary skills in the art, will not be described in detail here and also should not be used as limitations on the present application.

A method for driving a display panel is also provided in an embodiment of the present disclosure. The method includes: controlling a plurality of kinds of gate drive circuits to output a plurality of kinds of gate drive signals to a plurality of transistors in a pixel drive circuit, wherein the plurality of kinds of gate drive signals are divided into at least two groups, high-level voltages of gate drive signals in a same group are the same, and low-level voltages of the gate drive signals in a same group are the same; high-level voltages of gate drive signals in different groups are different, and/or low-level voltages of gate drive signals in different groups are different.

In some exemplary implementations, the pixel drive circuit includes a data writing transistor, a drive transistor and a light emitting control transistor. The data writing transistor is configured to write a data voltage provided by a data line to the drive transistor when a gate control signal provided by a scan line is effective; the drive transistor is configured to generate a drive current according to the data voltage; and the light emitting control transistor is configured to control a drive current generated by the drive transistor to flow through the light emitting element to drive the light emitting element to emit light when a light emitting control signal provided by a light emitting line is effective.

The plurality of kinds of gate drive signals include a gate control signal for controlling the data writing transistor to turn on and off, and a light emitting control signal for controlling the light emitting control transistor to turn on and off.

The plurality of kinds of gate drive signals are divided into two groups, wherein the first group of gate drive signals includes the gate control signal, and the second group of gate drive signals includes the light emitting control signal.

In some exemplary implementations, a high-level voltage of the first group of gate drive signals is greater than a high-level voltage of the second group of gate drive signals, and/or a low-level voltage of the first group of gate drive signals is greater than a low-level voltage of the second group of gate drive signals.

In some exemplary implementations, the pixel drive circuit further includes a reset transistor configured to when a reset control signal is effective, reset at least one of: an anode of the light emitting element, a first electrode of the drive transistor, and a second electrode of the drive transistor; the plurality of kinds of gate drive signals include a reset control signal for controlling the reset transistor to turn on and off.

When the reset control signal and the gate control signal are correlated signals, the first group of gate drive signals includes the reset control signal; and when the reset control signal and the gate control signal are uncorrelated signals, the second group of gate drive signals includes the reset control signal.

In some exemplary implementations, the pixel drive circuit includes a drive transistor, a data writing transistor, a reset transistor, a light emitting control transistor and a compensation transistor. The data writing transistor is configured to write a data voltage provided by a data line to the drive transistor when a first gate control signal provided by a first scan line is effective. The drive transistor is configured to generate a drive current according to the data voltage. The light emitting control transistor is configured to control the drive current generated by the drive transistor to flow through the light emitting element to drive the light emitting element to emit light when the light emitting control signal provided by the light emitting line is effective. The reset transistor is configured to when a reset control signal is effective, reset at least one of: an anode of the light emitting element, a first electrode of the drive transistor and a second electrode of the drive transistor. The compensation transistor is configured to perform threshold compensation on the drive transistor when a second gate control signal provided by a second scan line is effective.

The plurality of kinds of gate drive signals include a first gate control signal for controlling the data writing transistor to turn on and off, a second gate control signal for controlling the compensation transistor to turn on and off, a reset control signal for controlling the reset transistor to turn on and off, and a light emitting control signal for controlling the light emitting control transistor to turn on and off.

The plurality of kinds of gate drive signals are divided into three groups, wherein a first group of gate drive signals includes the first gate control signal, a second group of gate drive signals includes the second gate control signal, and a third group of gate drive signals includes the reset control signal and the light emitting control signal.

In some exemplary implementations, a high-level voltage of the first group of gate drive signals is greater than a high-level voltage of the third group of gate drive signals, and/or a low-level voltage of the first group of gate drive signals is greater than a low-level voltage of the third group of gate drive signals.

A high-level voltage of the second group of gate drive signals is less than the high-level voltage of the third group of gate drive signals, and/or a low-level voltage of the second group of gate drive signals is less than the low-level voltage of the third group of gate drive signals.

In some exemplary implementations, the high-level voltage of the first group of gate drive signals ranges from 9V to 10V, the high-level voltage of the second group of gate drive signals ranges from 6V to 7V, and the high-level voltage of the third group of gate drive signals ranges from 7.5V to 8.5V.

In some exemplary implementations, the low-level voltage of the first group of gate drive signals ranges from −6V to −7V, the low-level voltage of the second group of gate drive signals ranges from −8V to −9V, and the low-level voltage of the third group of gate drive signals ranges from −7V to −8V.

In some exemplary implementations, the pixel drive circuit includes a drive transistor, a data writing transistor, a first reset transistor, a second reset transistor, a light emitting control transistor and a compensation transistor. The data writing transistor is configured to write a data voltage provided by a data line to the drive transistor when a first gate control signal provided by a first scan line is effective. The drive transistor is configured to generate a drive current according to the data voltage. The light emitting control transistor is configured to control the drive current generated by the drive transistor to flow through the light emitting element to drive the light emitting element to emit light when the light emitting control signal provided by the light emitting line is effective. The first reset transistor is configured to reset a second electrode of the drive transistor when a first reset control signal is effective. The second reset transistor is configured to reset an anode of the light emitting element and a first electrode of the drive transistor when a second reset control signal is effective. The compensation transistor is configured to perform threshold compensation on the drive transistor when a second gate control signal provided by a second scan line is effective.

The plurality of kinds of gate drive signals include a first gate control signal for controlling the data writing transistor to turn on and off, a second gate control signal for controlling the compensation transistor to turn on and off, a first reset control signal for controlling the first reset transistor to turn on and off, a second reset control signal for controlling the second reset transistor to turn on and off, and a light emitting control signal for controlling the light emitting control transistor to turn on and off.

The plurality of kinds of gate drive signals are divided into five groups, wherein a first group includes the first gate control signal, a second group includes the second gate control signal, a third group includes the first reset control signal, a fourth group includes the second reset control signal, and a fifth group includes the light emitting control signal.

The drawings of the embodiments of the present disclosure only involve structures involved in the embodiments of the present disclosure, and other structures may refer to a general design.

For the sake of clarity, a thickness and size of a layer or a micro structure are enlarged in the accompanying drawings used for describing the embodiments of the present disclosure. It may be understood that when an element such as a layer, film, region, or substrate is described as being “on” or “under” another element, the element may be “directly” located “on” or “under” the another element, or there may be an intermediate element.

Although implementations of the present disclosure are disclosed above, contents described are only implementations used for ease of understanding of the present disclosure, but not intended to limit the present disclosure. Any of those skilled in the art of the present disclosure can make any modifications and variations in the implementation and details without departing from the spirit and scope of the present disclosure. However, the protection scope of the present disclosure should be subject to the scope defined by the appended claims.

1. A display panel, comprising a plurality of kinds of gate drive circuits, and further comprising a plurality of sub-pixels arranged in an array, wherein a sub-pixel of the plurality of sub-pixels comprises a pixel drive circuit and a light emitting element, the pixel drive circuit comprises a plurality of transistors, wherein,
the plurality of kinds of gate drive circuits are configured to output a plurality of kinds of gate drive signals to the plurality of transistors in the pixel drive circuit, wherein each kind of gate drive circuit outputs one kind of gate drive signal, the plurality of kinds of gate drive signals are divided into at least two groups, high-level voltages of gate drive signals in a same group are the same, and low-level voltages of gate drive signals in a same group are the same; high-level voltages of gate drive signals in different groups are different, and/or low-level voltages of gate drive signals in different groups are different; and
the pixel drive circuit is configured to receive the plurality of kinds of gate drive signals and drive the light emitting element to emit light according to the received plurality of kinds of gate drive signals.

2. The display panel of claim 1, wherein the pixel drive circuit comprises a data writing transistor, a drive transistor and a light emitting control transistor, wherein the data writing transistor is configured to write a data voltage provided by a data line to the drive transistor when a gate control signal provided by a scan line is effective; the drive transistor is configured to generate a drive current according to the data voltage; and the light emitting control transistor is configured to control the drive current generated by the drive transistor to flow through the light emitting element to drive the light emitting element to emit light when a light emitting control signal provided by a light emitting line is effective;
the plurality of kinds of gate drive signals comprise a gate control signal for controlling the data writing transistor to turn on and off, and a light emitting control signal for controlling the light emitting control transistor to turn on and off, and
the plurality of kinds of gate drive signals are divided into two groups, wherein a first group of gate drive signals comprises the gate control signal, and a second group of gate drive signals comprises the light emitting control signal.

3. The display panel of claim 2, wherein a high-level voltage of the first group of gate drive signals is greater than a high-level voltage of the second group of gate drive signals, and/or a low-level voltage of the first group of gate drive signals is greater than a low-level voltage of the second group of gate drive signals.

4. The display panel of claim 2, wherein the pixel drive circuit further comprises a reset transistor configured to, when a reset control signal is effective, reset at least one of: an anode of the light emitting element, a first electrode of the drive transistor, and a second electrode of the drive transistor; wherein the plurality of kinds of gate drive signals comprise a reset control signal for controlling the reset transistor to turn on and off,
when the reset control signal and the gate control signal are correlated signals, the first group of gate drive signals comprises the reset control signal; and
when the reset control signal and the gate control signal are uncorrelated signals, the second group of gate drive signals comprises the reset control signal.

5. The display panel of claim 1, wherein the pixel drive circuit comprises a drive transistor, a data writing transistor, a reset transistor, a light emitting control transistor and a compensation transistor, wherein the data writing transistor is configured to write a data voltage provided by a data line to the drive transistor when a first gate control signal provided by a first scan line is effective; the drive transistor is configured to generate a drive current according to the data voltage; the light emitting control transistor is configured to control the drive current generated by the drive transistor to flow through the light emitting element to drive the light emitting element to emit light when a light emitting control signal provided by a light emitting line is effective; the reset transistor is configured to, when a reset control signal is effective, reset at least one of: an anode of the light emitting element, a first electrode of the drive transistor and a second electrode of the drive transistor; and the compensation transistor is configured to perform threshold compensation on the drive transistor when a second gate control signal provided by a second scan line is effective;
the plurality of kinds of gate drive signals comprise a first gate control signal for controlling the data writing transistor to turn on and off, a second gate control signal for controlling the compensation transistor to turn on and off, a reset control signal for controlling the reset transistor to turn on and off, and a light emitting control signal for controlling the light emitting control transistor to turn on and off;
the plurality of kinds of gate drive signals are divided into three groups, wherein a first group of gate drive signals comprises the first gate control signal, a second group of gate drive signals comprises the second gate control signal, and a third group of gate drive signals comprises the reset control signal and the light emitting control signal.

6. The display panel of claim 5, wherein a high-level voltage of the first group of gate drive signals is greater than a high-level voltage of the third group of gate drive signals, and/or a low-level voltage of the first group of gate drive signals is greater than a low-level voltage of the third group of gate drive signals;
a high-level voltage of the second group of gate drive signals is less than the high-level voltage of the third group of gate drive signals, and/or a low-level voltage of the second group of gate drive signals is less than the low-level voltage of the third group of gate drive signals.

7. The display panel of claim 6, wherein the high-level voltage of the first group of gate drive signals ranges from 9V to 10V, the high-level voltage of the second group of gate drive signals ranges from 6V to 7V, and the high-level voltage of the third group of gate drive signals ranges from 7.5V to 8.5V.

8. The display panel of claim 6, wherein the low-level voltage of the first group of gate drive signals ranges from −6V to −7V, the low-level voltage of the second group of gate drive signals ranges from −8V to −9V, and the low-level voltage of the third group of gate drive signals ranges from −7V to −8V.

9. The display panel of claim 1, wherein the pixel drive circuit comprises a drive transistor, a data writing transistor, a first reset transistor, a second reset transistor, a light emitting control transistor and a compensation transistor, wherein the data writing transistor is configured to write a data voltage provided by a data line to the drive transistor when a first gate control signal provided by a first scan line is effective; the drive transistor is configured to generate a drive current according to the data voltage; the light emitting control transistor is configured to control the drive current generated by the drive transistor to flow through the light emitting element to drive the light emitting element to emit light when a light emitting control signal provided by a light emitting line is effective; the first reset transistor is configured to reset a second electrode of the drive transistor when a first reset control signal is effective; the second reset transistor is configured to reset an anode of the light emitting element and a first electrode of the drive transistor when a second reset control signal is effective; and the compensation transistor is configured to perform threshold compensation on the drive transistor when a second gate control signal provided by a second scan line is effective;
the plurality of kinds of gate drive signals comprise a first gate control signal for controlling the data writing transistor to turn on and off, a second gate control signal for controlling the compensation transistor to turn on and off, a first reset control signal for controlling the first reset transistor to turn on and off, a second reset control signal for controlling the second reset transistor to turn on and off, and a light emitting control signal for controlling the light emitting control transistor to turn on and off;
the plurality of kinds of gate drive signals are divided into five groups, wherein a first group comprises the first gate control signal, a second group comprises the second gate control signal, a third group comprises the first reset control signal, a fourth group comprises the second reset control signal, and a fifth group comprises the light emitting control signal.

10. A display apparatus, comprising the display panel of claim 1.

11. A method for driving a display panel, comprising:
controlling a plurality of kinds of gate drive circuits to output a plurality of kinds of gate drive signals to a plurality of transistors in a pixel drive circuit, wherein the plurality of kinds of gate drive signals are divided into at least two groups, high-level voltages of gate drive signals in a same group are the same, and low-level voltages of gate drive signals in a same group are the same; high-level voltages of gate drive signals in different groups are different, and/or low-level voltages of gate drive signals in different groups are different.

12. The display panel of claim 9, wherein a high-level voltage of the first group of gate drive signals is greater than a high-level voltage of the third group of gate drive signals, and/or a low-level voltage of the first group of gate drive signals is greater than a low-level voltage of the third group of gate drive signals;
a high-level voltage of the second group of gate drive signals is less than the high-level voltage of the third group of gate drive signals, and/or a low-level voltage of the second group of gate drive signals is less than the low-level voltage of the third group of gate drive signals.

13. The display panel of claim 9, wherein a high-level voltage of the fourth group of gate drive signals is equal to or approximately equal to the high-level voltage of the third group of gate drive signals, and/or a low-level voltage of the fourth group of gate drive signals is equal to or approximately equal to the low-level voltage of the third group of gate drive signals.

14. The display panel of claim 9, wherein a high-level voltage of the fifth group of gate drive signals is equal to or approximately equal to the high-level voltage of the third group of gate drive signals, and/or a low-level voltage of the fifth group of gate drive signals is equal to or approximately equal to the low-level voltage of the third group of gate drive signals.

15. The display panel of claim 9, wherein a high-level voltage of the first group of gate drive signals ranges from 9V to 10V, a high-level voltage of the second group of gate drive signals ranges from 6V to 7V, a high-level voltage of the third group of gate drive signals ranges from 7.5V to 8.5V, a high-level voltage of the fourth group of gate drive signals ranges from 7.5V to 8.5V, and a high-level voltage of the fifth group of gate drive signals ranges from 7.5V to 8.5V.

16. The display panel of claim 9, wherein a low-level voltage of the first group of gate drive signals ranges from −6V to −7V, a low-level voltage of the second group of gate drive signals ranges from −8V to −9V, a low-level voltage of the third group of gate drive signals ranges from −7V to −8V, a low-level voltage of the fourth group of gate drive signals ranges from −7V to −8V, and a low-level voltage of the fifth group of gate drive signals ranges from −7V to −8V.

17. The method for driving the display panel of claim 11, wherein the pixel drive circuit comprises a data writing transistor, a drive transistor and a light emitting control transistor, wherein the data writing transistor is configured to write a data voltage provided by a data line to the drive transistor when a gate control signal provided by a scan line is effective; the drive transistor is configured to generate a drive current according to the data voltage; and the light emitting control transistor is configured to control the drive current generated by the drive transistor to flow through the light emitting element to drive the light emitting element to emit light when a light emitting control signal provided by a light emitting line is effective;
the plurality of kinds of gate drive signals comprise a gate control signal for controlling the data writing transistor to turn on and off, and a light emitting control signal for controlling the light emitting control transistor to turn on and off, and
the plurality of kinds of gate drive signals are divided into two groups, wherein a first group of gate drive signals comprises the gate control signal, and a second group of gate drive signals comprises the light emitting control signal.

18. The method for driving the display panel of claim 17, wherein a high-level voltage of the first group of gate drive signals is greater than a high-level voltage of the second group of gate drive signals, and/or a low-level voltage of the first group of gate drive signals is greater than a low-level voltage of the second group of gate drive signals.

19. The method for driving the display panel of claim 17, wherein the pixel drive circuit further comprises a reset transistor configured to, when a reset control signal is effective, reset at least one of: an anode of the light emitting element, a first electrode of the drive transistor, and a second electrode of the drive transistor; wherein the plurality of kinds of gate drive signals comprise a reset control signal for controlling the reset transistor to turn on and off;
when the reset control signal and the gate control signal are correlated signals, the first group of gate drive signals comprises the reset control signal; and
when the reset control signal and the gate control signal are uncorrelated signals, the second group of gate drive signals comprises the reset control signal.

20. The method for driving the display panel of claim 11, wherein the pixel drive circuit comprises a drive transistor, a data writing transistor, a reset transistor, a light emitting control transistor and a compensation transistor, wherein the data writing transistor is configured to write a data voltage provided by a data line to the drive transistor when a first gate control signal provided by a first scan line is effective; the drive transistor is configured to generate a drive current according to the data voltage; the light emitting control transistor is configured to control the drive current generated by the drive transistor to flow through the light emitting element to drive the light emitting element to emit light when a light emitting control signal provided by a light emitting line is effective; the reset transistor is configured to, when a reset control signal is effective, reset at least one of: an anode of the light emitting element, a first electrode of the drive transistor and a second electrode of the drive transistor; and the compensation transistor is configured to perform threshold compensation on the drive transistor when a second gate control signal provided by a second scan line is effective;
the plurality of kinds of gate drive signals comprise a first gate control signal for controlling the data writing transistor to turn on and off, a second gate control signal for controlling the compensation transistor to turn on and off, a reset control signal for controlling the reset transistor to turn on and off, and a light emitting control signal for controlling the light emitting control transistor to turn on and off;
the plurality of kinds of gate drive signals are divided into three groups, wherein a first group of gate drive signals comprises the first gate control signal, a second group of gate drive signals comprises the second gate control signal, and a third group of gate drive signals comprises the reset control signal and the light emitting control signal.
